(19) United States
(12) Patent Application Publication
(10) Pub. No.: US 2012/0295673 A1
(43) Pub. Date: Nov. 22, 2012

(54) WIRELESS SYSTEM AND METHOD FOR CONTROLLING WIRELESS SYSTEM

(76) Inventors: Sang-Jung Yang, Kaohsiung City (TW); Chih-Wei Ko, Taipei City (TW)

(21) Appl. No.: 13/109,018

(22) Filed: May 17, 2011

(51) Int. Cl. H04W 52/02

(52) U.S. Cl. 455/574

(57) ABSTRACT

A wireless system includes: a paging chip arranged to selectively generate a notification signal according to a paging signal; and a processing chip arranged to switch from a first mode to a second mode upon receiving the notification signal, wherein power consumption of the processing chip in the first mode is lower than power consumption of the processing chip in the second mode, and the paging chip and the processing chip are externally coupled with each other.

### BACKGROUND

The present invention relates to a wireless system and method for controlling the wireless system, and more particularly to a wireless system with low leakage current and low power consumption and related control method.

A 2G or 3G wireless communication system includes a plurality of base stations. Each base station installed at a fixed location is used to receive and transmit signals from/to mobile units located at the corresponding cell. For instance, within a Global System for Mobile communications (GSM), the above-mentioned mobile units are mobile stations (MS), and within a Wideband Code Division Multiple Access (WCDMA) system, the above-mentioned mobile units are user equipments (UE). To prolong usage time of the mobile unit, power consumption of the mobile unit should be reduced. For example, the mobile unit is controlled to enter a sleep mode (or an idle mode) to reduce power consumption when the mobile unit is not used to receive signals or transmit signals for a period of time. The corresponding base station transmits a paging signal to the mobile unit to inform the mobile unit of an incoming call. The mobile unit periodically recovers from the sleep mode to receive the paging signal issued from the wireless communication system. In other words, the mobile unit may still need to consume some power to turn on related circuits such as a modem, for receiving the paging signal and decoding the received paging signal to determine if there is an incoming call. Furthermore, another factor affecting the usage time and standby time of the mobile unit is the leakage current of the mobile unit. In addition, the leakage current may be aggravated when the manufacturing process technology of the chips in the mobile unit uses a deep submicron process. Further reducing the power consumption and the leakage current of the mobile unit is always an important topic for designing the mobile units.

### SUMMARY

One of the objectives is therefore to provide a wireless system with low leakage current and low power consumption and the related control method.

According to a first embodiment of the present invention, a wireless system is disclosed. The wireless system comprises a paging chip and a processing chip. The paging chip is arranged to selectively generate a notification signal according to a paging signal. The processing chip is arranged to switch from a first mode to a second mode upon receiving the notification signal, wherein power consumption of the processing chip in the first mode is lower than power consumption of the processing chip in the second mode, and the paging chip and the processing chip are externally coupled with each other.

According to a second embodiment of the present invention, a method for controlling a wireless system is disclosed, wherein the wireless system comprises a paging chip and a processing chip. The method comprises the steps: arranging the paging chip and the processing chip to externally couple with each other; arranging the paging chip to selectively generate a notification signal according to a paging signal; and controlling the processing chip to switch from a first mode to a second mode upon receiving the notification signal, wherein power consumption of the processing chip in the first mode is lower than power consumption of the processing chip in the second mode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless system according to an embodiment of the present invention.

FIG. 2 is a diagram illustrating a paging decoder according to an embodiment of the present invention.

FIG. 3 is a timing diagram illustrating the operation of a sequencer to control the on/off of the paging decoder according to an embodiment of the present invention.

FIG. 4 is a flowchart illustrating a method of controlling a wireless system according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

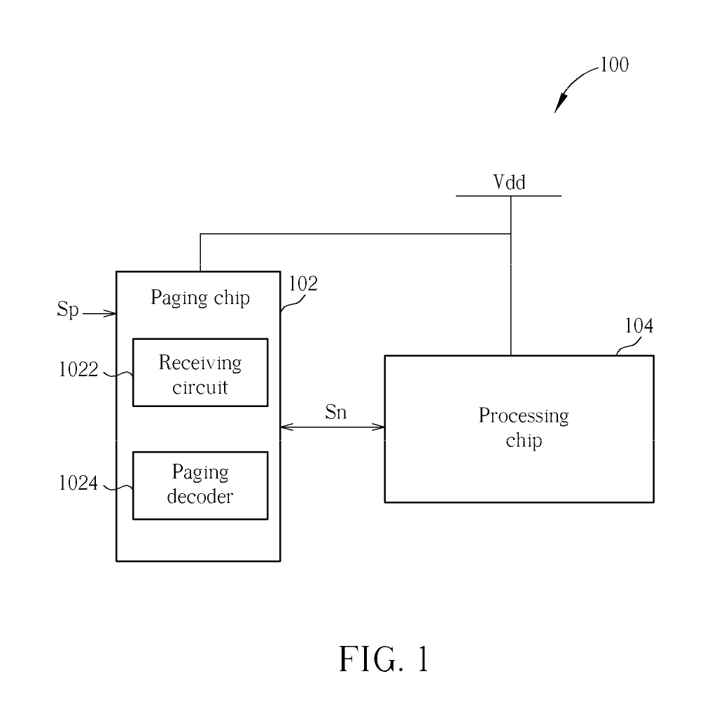

Please refer to FIG. 1. FIG. 1 is a diagram illustrating a wireless system 100 according to an embodiment of the present invention. For brevity, the wireless system 100 is a mobile phone, and the wireless system 100 comprises a paging chip 102 and a processing chip 104. The processing chip 104 is the main chip of the wireless system. The paging chip 102 is arranged to selectively generate a notification signal Sn according to a paging signal Sp. The processing chip 104 is arranged to switch from a first mode to a second mode upon receiving the notification signal Sn. Power consumption of the processing chip 104 in the first mode is lower than power consumption of the processing chip 104 in the second mode, and the paging chip 102 and the processing chip 104 are externally coupled with each other as shown in FIG. 1. In addition, the paging chip 102 and the processing chip 104 are powered by a supply voltage Vdd.

In this preferred embodiment, the first mode can be a shut down mode, a sleeping mode, an idle mode, or any other power saving modes, and the second mode can be a normal operation mode or any other awake modes. Furthermore, when the wireless system 100 is in a standby mode, the processing chip 104 is arranged to operate in the first mode and the paging chip 102 is arranged to receive the paging signal Sp periodically. Once the paging chip 102 detects that the paging signal Sp is a valid paging signal for the wireless system 100, the paging chip 102 generates the notification signal Sn to the processing chip 104. In other words, when the paging signal Sp is a valid paging signal for the wireless system 100, this means that an incoming call is arriving at the wireless system 100, and the wireless system 100 should decode and analyze the paging signal Sp. In addition, as the paging signal Sp contains the information of the caller, the paging chip 102 can also directly output the valid paging signal Sp as the notification signal Sn to wake up the processing chip 104, then the processing chip 104 can use the notification signal Sn (i.e., the valid paging signal Sp) to proceed with subsequent operations, but the present invention is not limited to this feature. In another preferred embodiment, the paging chip 102 may also send both the notification signal Sn and the paging signal Sp to the processing chip 104 when the paging chip 102 detects that the received paging signal Sp is a valid paging signal.

In this preferred embodiment, the paging chip 102 comprises a receiving circuit 1022 and a paging decoder 1024. The receiving circuit 1022 is arranged to wirelessly receive the paging signal Sp. The paging decoder 1024 is arranged to decode the paging signal Sp to selectively generate the notification signal Sn according to the paging signal Sp. It should be noted that the receiving circuit 1022 can also be the receiver of the wireless system 100 when the wireless system 100 is in the normal operation mode. In other words, the paging decoder 1024 can be installed into the circuit block of the receiver or a radio frequency (RF) chip of the wireless system 100 in this preferred embodiment. However, in another preferred embodiment, the paging decoder 1024 can also be installed into the power management circuit block or any other circuit block except for the processing chip 104, which also belongs to the scope of the present invention.

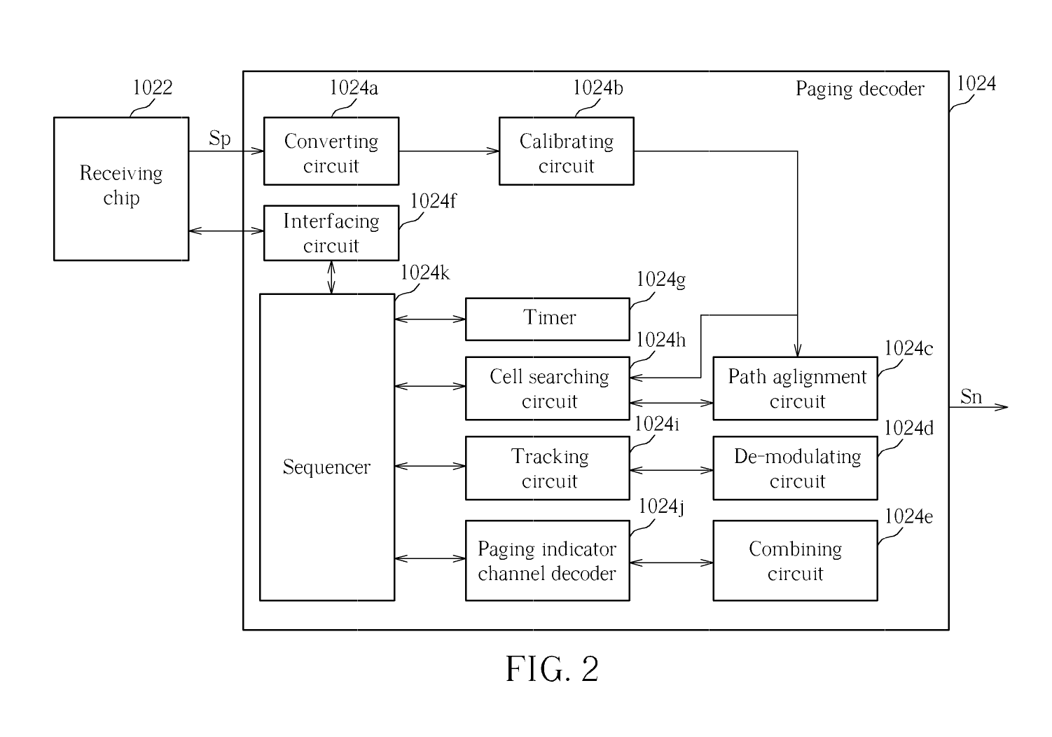

Please refer to FIG. 2. FIG. 2 is a diagram illustrating the paging decoder 1024 according to an embodiment of the present invention. For description, the receiving circuit 1022 is also shown in FIG. 2. The paging decoder 1024 comprises a converting circuit 1024a, a calibrating circuit 1024b, a path alignment circuit 1024c, a de-modulating circuit 1024d, a combining circuit 1024e, an interfacing circuit 1024f, a timer 1024g, a cell searching circuit 1024h, a tracking circuit 1024i, a paging indicator channel decoder 1024j, and a sequencer 1024k. In this preferred embodiment, the converting circuit 1024a is an analog-to-digital converter for converting the valid paging signal Sp (i.e., the notification signal) into a digital-based signal from the analog-based signal. The calibrating circuit 1024b is a receiver digital front-end circuit utilized for calibrating an RF (Radio Frequency) signal and/or performing gain tuning of the RF signal. The path alignment circuit 1024c is arranged to align multi-path input signals received from various transmitting paths for detecting the signal power of each path. The de-modulating circuit 1024d, which can be a de-spreader circuit, is arranged to de-spread the spread spectrum input signal. The combining circuit 1024e is arranged to combine the de-spread signals of various transmitting paths. The interfacing circuit 1024f is a binary sequential interface/binary parallel interface for providing a control interface between the receiving circuit 1022 and the paging decoder 1024. The timer 1024g is arranged to count a first predetermined time T1 to generate a first interrupt signal Si1. The cell searching circuit 1024h is arranged to monitor the base stations around the cell that the wireless system 100 is located in. The tracking circuit 1024i is arranged to track the movement of the wireless system 100. The paging indicator channel decoder 1024j is arranged to decode the paging signal Sp to determine if the paging signal Sp is a valid paging signal for the wireless system 100. The paging indicator channel decoder 1024j generates the notification signal Sn when the paging signal Sp is the valid paging signal for the wireless system 100.

The sequencer 1024k is arranged to switch the paging decoder 1024 from a third mode to a fourth mode in response to the first interrupt signal Si1. Power consumption of the paging decoder 1024 in the third mode is lower than power consumption of the paging decoder 1024 in the fourth mode. Furthermore, the timer 1024g further counts a second predetermined time T2 to generate a second interrupt signal Si2, and the sequencer 1024 is further arranged to switch the paging decoder 1024 from the fourth mode to the third mode in response to the second interrupt signal Si2. In this preferred embodiment, the third mode can be a shut down mode, a sleeping mode, an idle mode, or any other power saving mode, and the fourth mode can be a normal operation mode or any other awake mode.

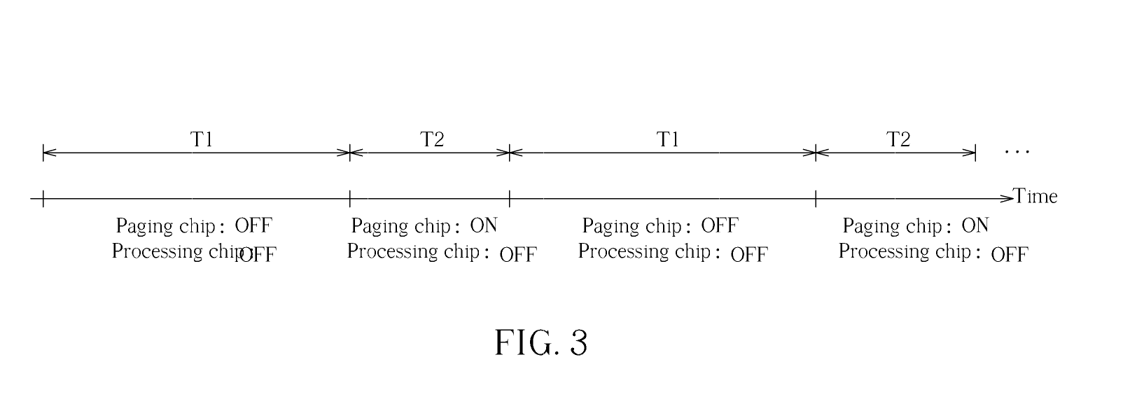

Please refer to FIG. 3. FIG. 3 is a timing diagram illustrating on/off operation of the paging chip 102 according to an embodiment of the present invention. When the wireless system 100 is in the standby mode, the receiving circuit 1022 and the paging decoder 1024 are in the shut down mode (or the sleeping mode, the idle mode, or any other power saving mode). However, the timer 1024g in the paging decoder 1024 starts to count the first predetermined time T1 when the wireless system 100 enters the standby mode. When the first predetermined time T1 is up, the timer 1024g generates the first interrupt signal Si1 to the sequencer 1024k to switch the paging decoder 1024 from the shut down mode to the normal operation mode. It should be noted that when the paging decoder 1024 is turned on, the receiving circuit 1022 is also turned on to receive the paging signal Sp transmitted from the base station. It should be noted that the receiving circuit 1022 can be turned on before or after the turn on of the paging decoder 1024. Then, the timer 1024g in the paging decoder 1024 starts to count the second predetermined time T2 when the paging decoder 1024 is turned on. When the second predetermined time T2 is up, the timer 1024g generates the second interrupt signal Si2 to the sequencer 1024k to switch the paging decoder 1024 from the normal operation mode to the shut down mode. Then, the timer 1024g again starts to count the first predetermined time T1 to repeat the above procedure.

In the time interval of T1, the whole wireless system 100 is in the shut down mode except for the timer 1024g. In the time interval of T2, the paging decoder 1024 is turned on to decode the received paging signal Sp in order to determine if the paging signal Sp is a valid paging signal for the wireless system 100. More specifically, in the time interval of T2, the paging indicator channel decoder 1024j decodes the paging signal Sp to determine if the paging signal Sp is the valid paging signal for the wireless system 100.

In practice, the sequencer 1024k may be implemented by a microcontroller unit executing sequencer software, a pure hardware sequencer, or a combination of software and hardware. In other words, timing control can be done by software or by hardware. Furthermore, the paging chip 102 and the processing chip 104 may be implemented by the same or different semiconductor manufacturing process technology. When the paging chip 102 and the processing chip 104 are implemented by the same semiconductor manufacturing process technology, the paging chip 102 and the processing chip 104 have the same minimum line width. When the paging chip 102 and the processing chip 104 are implemented by different semiconductor manufacturing process technologies, the paging chip 102 and the processing chip 104 have different minimum line widths. More specifically, when the paging chip 102 and the processing chip 104 are implemented by different semiconductor manufacturing process technologies, the semiconductor manufacturing process technology utilized to implement the processing chip 104 is typically more advanced than the semiconductor manufacturing process technology utilized to implement the paging chip 102. In other words, the minimum line width of the paging chip 102 is larger than the minimum line width of the processing chip 104. For example, the processing chip 104 can be manufactured by a smaller size process technology such as 90/65/40/28 nm, so the size of the processing chip 104 is relatively small. The paging chip 102 on the other hand can be manufactured by a larger size process technology such as 0.18/0.13 um, so the paging chip 102 consumes less leakage power.

Please refer to FIG. 1 again. When the wireless system 100 is in the standby mode, the corresponding base station periodically sends the paging signal Sp to the wireless system 100 each time interval of Tp, i.e., T1+T2. Then, the wireless system 100 wakes up for a time interval of T2 to receive the paging signal Sp. If the paging chip 102 and the processing chip 104 are implemented as a single chip, the power (i.e., the product of time interval and the consumed current) P1 consumed by the single chip in the time interval Tp is as follows:

P1=A1*T2+A2*T1,

where A1 is the current consumed by the single chip when the single chip receives the paging signal Sp, and A2 is the leakage current of the single chip when the single chip is in the standby mode and does not receive the paging signal Sp. Therefore, the power P1 is the total power consumed by the single chip in the time interval of Tp. As the paging chip 102 and the processing chip 104 are implemented as a single chip in this example, the processing chip 104 can not be turned off completely in the time interval of T2.

However, in this preferred embodiment, the paging chip 102 and the processing chip 104 are externally coupled with each other, therefore the processing chip 104 can be completely turned off when the wireless system 100 is in the standby mode, i.e., during the time interval T1. The power (i.e., the product of time interval and the consumed current) P2 consumed by the wireless system 100 is:

P2=A3*T2+A4*T1,

where A3 is the current consumed by the wireless system 100 when the paging chip 102 receives the paging signal Sp, and A4 is the leakage current of the wireless system 100 when the wireless system 100 is in the standby mode and does not receive the paging signal Sp. In the time interval T2, the current A3 consumed by the wireless system 100 is mainly contributed by the current consumed by the paging chip 102, since the processing chip 104 is completely turned off in this interval. Similarly, in the time interval of T1, the leakage current A4 is mainly the leakage current of the paging chip 102, since the leakage current of the processing chip 104 is almost zero when the processing chip 104 is completely turned off.

Accordingly, the current A3 must be much smaller than the current A1 since the processing chip 104 can not be completely turned off when the paging chip 102 and the processing chip 104 are implemented as the single chip, and the processing chip 104 can be completely turned off in the present wireless system 100 when the paging chip 102 and the processing chip 104 are externally coupled with each other. Furthermore, the current A4 must be much smaller than the current A2, since the leakage current of the only paging chip 102 in the present wireless system 100 must be smaller than the leakage current of both the paging chip 102 and the processing chip 104 in the single chip. Therefore, the power P1 consumed by the single chip in the time interval Tp is much smaller than the power consumed by the wireless system 100 in the time interval Tp.

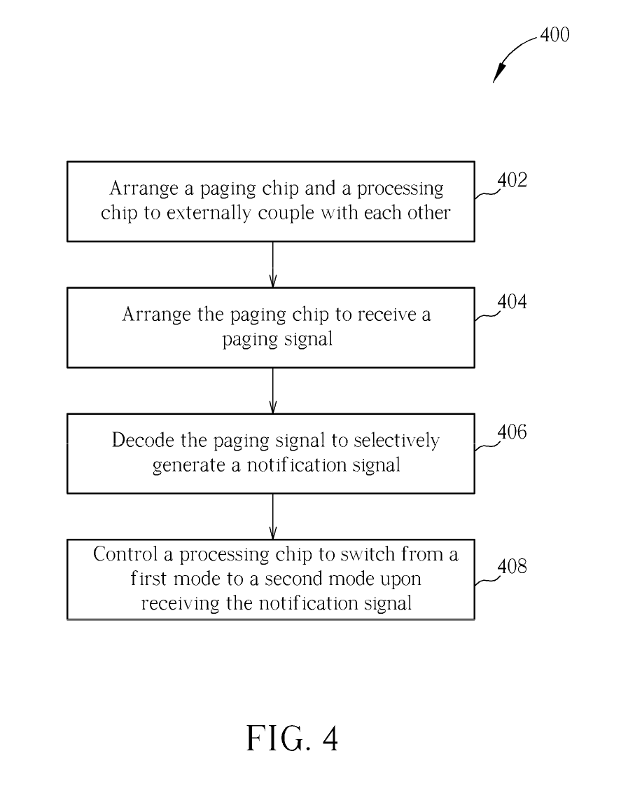

Briefly the operation of the above embodiments can be summarized in the steps shown in FIG. 4. FIG. 4 is a flowchart illustrating a method 400 of controlling a wireless system according to an embodiment of the present invention. The wireless system can be referred from the above mentioned wireless system 100 for brevity. Provided that substantially the same result is achieved, the steps of the flowchart shown in FIG. 4 need not be in the exact order shown and need not be contiguous, that is, other steps can be intermediate. The method 400 comprises the steps:

Step 402: Arrange the paging chip 102 and the processing chip 104 to externally couple with each other;

Step 404: Arrange the paging chip 102 to receive the paging signal Sp;

Step 406: Decode the paging signal Sp to selectively generate the notification signal Sn;

Step 408: Control the processing chip 104 to switch from the first mode to the second mode upon receiving the notification signal, wherein power consumption of the processing chip 104 in the first mode is lower than power consumption of the processing chip 104 in the second mode.

In step 402, the paging chip 102 and the processing chip 104 are implemented to externally couple with each other rather than being implemented as a single chip. By doing this, the processing chip 104 can be turned off completely to save the leakage power of the wireless system 100, and the paging chip 102 is turned on periodically to receive the paging signal Sp. More specifically, the paging chip 102 receives and decodes the paging signal Sp. When the paging chip 102 detects that the paging signal Sp is not the valid paging signal for the wireless system 100, the paging chip 102 continues to receive the paging signal Sp in the next period. Once the paging chip 102 detects that the paging signal Sp is the valid paging signal for the wireless system 100, the paging chip 102 generates the notification signal Sn to wake up the processing chip 104 from the shut down mode in step 408. Then, the leakage currents and the power consumption of the paging chip 102 and the processing chip 104 can be minimized.

Briefly, by externally coupling the paging chip 102 and the processing chip 104 with each other, the processing chip 104 can be turned off completely when the wireless system 100 is in the standby mode. Then, the leakage currents and the power consumption of the wireless system 100 in the standby mode can be minimized and consequently prolong the usage time of the wireless system 100.

Those skilled in the art will readily observe that numerous modifications and alterations of the device and method may be made while retaining the teachings of the invention.

What is claimed is:

1. A wireless system, comprising:
a paging chip, arranged to selectively generate a notification signal according to a paging signal; and
a processing chip, arranged to switch from a first mode to a second mode upon receiving the notification signal;
wherein power consumption of the processing chip in the first mode is lower than power consumption of the processing chip in the second mode, and the paging chip and the processing chip are externally coupled with each other.

2. The wireless system of claim 1, wherein the paging chip comprises:
a receiving circuit, arranged to wirelessly receive the paging signal; and
a paging decoder, arranged to decode the paging signal to selectively generate the notification signal according to the paging signal.

3. The wireless system of claim 2, wherein the paging decoder comprises:
a paging indicator channel decoder, arranged to decode the paging signal to determine if the paging signal is a valid paging signal for the wireless system, wherein the paging indicator channel decoder generates the notification signal when the paging signal is the valid paging signal for the wireless system;
a timer, arranged to count a first predetermined time to generate a first interrupt signal; and
a sequencer, arranged to switch the paging decoder from a third mode to a fourth mode in response to the first interrupt signal, wherein power consumption of the paging decoder in the third mode is lower than power consumption of the paging decoder in the fourth mode.

4. The wireless system of claim 3, wherein the timer further counts a second predetermined time to generate a second interrupt signal, and the sequencer is further arranged to switch the paging decoder from the fourth mode to the third mode in response to the second interrupt signal.

5. The wireless system of claim 2, wherein the sequencer is implemented by a microcontroller unit executing sequencer software.

6. The wireless system of claim 2, wherein the sequencer is a pure hardware sequencer.

7. The wireless system of claim 1, wherein the paging chip and the processing chip have different minimum line width.

8. The wireless system of claim 7, wherein the minimum line width of the paging chip is larger than the minimum line width of the processing chip.

9. The wireless system of claim 1, wherein the first mode is a shut down mode, a sleeping mode, or an idle mode.

10. The wireless system of claim 1, wherein when the wireless system is in a standby mode, the processing chip is arranged to operate in the first mode and the paging chip is arranged to receive the paging signal periodically; and once the paging chip detects that the paging signal is a valid paging signal for the wireless system, the paging chip generates the notification signal to the processing chip.

11. The wireless system of claim 1, wherein when the paging chip detects that the paging signal is a valid paging signal for the wireless system, the paging chip outputs the valid paging signal as the notification signal.

12. A method for controlling a wireless system, wherein the wireless system comprises a paging chip and a processing chip, the method comprising:
arranging the paging chip and the processing chip to externally couple with each other;
arranging the paging chip to selectively generate a notification signal according to a paging signal; and
controlling the processing chip to switch from a first mode to a second mode upon receiving the notification signal;
wherein power consumption of the processing chip in the first mode is lower than power consumption of the processing chip in the second mode.

13. The method of claim 12, wherein the step of arranging the paging chip to selectively generate the notification signal comprises:
arranging a receiving circuit to wirelessly receive the paging signal; and
decoding the paging signal to selectively generate the notification signal according to the paging signal.

14. The method of claim 13, wherein the step of decoding the paging signal to selectively generate the notification signal according to the paging signal comprises:
arranging a paging indicator channel decoder to decode the paging signal to determine if the paging signal is a valid paging signal for the wireless system, and generate the notification signal when the paging signal is the valid paging signal for the wireless system;
counting a first predetermined time to generate a first interrupt signal; and
switching the paging chip from a third mode to a fourth mode in response to the first interrupt signal, wherein power consumption of the paging chip in the third mode is lower than power consumption of the paging chip in the fourth mode.

15. The method of claim 14, wherein the step of decoding the paging signal to selectively generate the notification signal according to the paging signal further comprises:
counting a second predetermined time to generate a second interrupt signal; and
switching the paging chip from the fourth mode to the third mode in response to the second interrupt signal.

16. The method of claim 12, wherein the first mode is a shut down mode, a sleeping mode, or an idle mode.

17. The method of claim 12, wherein when the wireless system is in a standby mode, the method further comprises:
arranging the processing chip to operate in the first mode and arranging the paging chip to receive the paging signal periodically;
arranging the paging chip to detect if the paging signal is a valid paging signal for the wireless system; and
arranging the paging chip to generate the notification signal to the processing chip once the paging signal is the valid paging signal for the wireless system.

18. The method of claim 12, further comprising:
arranging the paging chip to detect if the paging signal is a valid paging signal for the wireless system; and
arranging the paging chip to output the valid paging signal as the notification signal once the paging signal is the valid paging signal for the wireless system.
